(19) United States
(12) Patent Application Publication
(10) Pub. No.: US 2019/0041652 A1
(43) Pub. Date: Feb. 7, 2019

(54) DISPLAY SYSTEM, DISPLAY METHOD, AND PROGRAM

(71) Applicant: HONDA MOTOR CO., LTD., Tokyo (JP)

(72) Inventors: Hisashi Murayama, Wako-shi (JP); Hiroto Hayakawa, Wako-shi (JP)

(73) Assignee: HONDA MOTOR CO., LTD., Tokyo (JP)

(21) Appl. No.: 16/055,534

(22) Filed: Aug. 6, 2018

(30) Foreign Application Priority Data
Aug. 4, 2017 (JP) 2017-151928

(51) Int. Cl. G02B 27/01; B60K 35/00; G05D 1/00

(52) U.S. Cl. CPC G02B 27/0179; B60K 35/00; G05D 1/0088; G05D 2201/0213; B60K 2350/106; B60K 2350/962; B60K 2350/1096; G02B 2027/0183

(57) ABSTRACT

A display system includes: a display that displays an image; a retainer that retains the display at any one of a plurality of retention positions with different exposure amounts of the display, in a predetermined location in a vehicle cabin, and retains the display at one of the plurality of retention positions according to a state of a vehicle; and a display controller that causes the display to display an image with content according to the retention position at which the display is retained by the retainer.

### CROSS REFERENCES TO RELATED APPLICATIONS

The present application claims priority wider 35 U.S.C. § 119 to Japanese Patent Application No. 2017-151928, filed Aug. 4, 2017, entitled “Display System, Display Method, and Program.” The contents of this application are incorporated herein by reference in their entirety.

### BACKGROUND

### 1. Field

The present disclosure relates to a display system, a display method, and a program.

### 2. Description of the Related Art

A display system in related art is known, which includes a supporter that supports a display device, in a vehicle cabin, and displays information for a driver by the display device supported by the supporter (see, for instance, Japanese Patent No. 5629673). In the technique described in Japanese Patent No. 5629673, a supporter provided at a position on the near side (on the side of the driver seat) of a display facing the driver seat supports the display at a position under the boundary line formed by connecting the eyepoint of a driver and the lower side of the display surface of the display device.

### SUMMARY

However, the technique in related art does not change a retention state of the display device.

The present disclosure has been made in consideration of such a situation, and describes a display system, a display method, and a program that are capable of providing information according to a state of a vehicle.

(1) A display system including: a display (32) that displays an image; a retainer (40) that retains the display at any one of a plurality of retention positions with different exposure amounts of the display, in a predetermined location in a vehicle cabin (300), and retains the display at one of the plurality of retention positions according to a state of a vehicle (M); and a display controller (150) that causes the display to display an image with different content(s) according to the retention position at which the display is retained by the retainer.

(2) The display system according to (1), in which the display controller may cause the display to display an image in which the content is complete, by an exposed portion of the display.

(3) The display system according to (1) or (2), in which the retainer may retain the display at any one of the plurality of retention positions with different heights of an upper end of the display.

(4) The display system according to any one of (1) to (3), may further include an automatic drive controller (120,140) that performs automatic driving to control one or both of steering and acceleration/deceleration of the vehicle without an operation of an occupant of a vehicle. When the automatic driving is performed by the automatic drive controller, the retainer may change the retention position of the display so that the exposure amount of the display in the automatic driving is greater than the exposure amount of the display when the automatic driving is not performed by the automatic drive controller.

(5) The display system according to (4), in which when the automatic driving is performed by the automatic drive controller, the retainer may allow the display to be detached.

(6) The display system according to (4) or (5), may further include an indicator (47) that indicates a position of the retainer. When the vehicle is switched from the automatic driving to manual driving by an occupant, the display controller may cause the indicator to light on or flicker (blink).

(7) The display system according to (5), may further include an indicator that indicates a position of the retainer. When the vehicle is switched from the automatic driving to manual driving by an occupant, and the display has been detached from the retainer, the display controller may cause the indicator to light up or flicker.

(8) The display system according to any one of (1) to (7), in which the display may be a touch panel by which contact to a display area is detectable, and the display controller may cause the display to display an image for operating a device mounted in the vehicle via the contact.

(9) The display system according to any one of (1) to (8), in which the retainer may be included in a center console (304) in the vehicle cabin.

(10) The display system according to any one of (1) to (9), in which when a speed detected by a vehicle speed sensor is high (at a first speed), the retainer may change the retention position of the display so that the exposure amount of the display is smaller than the exposure amount of the display when the speed is low (at a second speed lower than the first speed).

(11) A display method performed by a computer, the method including: retaining a display that displays an image, by a retainer at any one of a plurality of retention positions with different exposure amounts of the display, in a predetermined location in a vehicle cabin; retaining the display by the retainer at one of the plurality of retention positions according to a state of a vehicle; and controlling a display controller that causes the display to display an image with content according to the retention position.

(12) A program causing a computer to execute process including: retaining a display that displays an image, by a retainer at any one of a plurality of retention positions with different exposure amounts of the display, in a predetermined location in a vehicle cabin; retaining the display by the retainer at one of the plurality of retention positions according to a state of a vehicle; and causing the display to display an image with content according to the retention position. It is understood and well known in the art that such program may be provided in a form of a computer program product having instructions stored in a computer readable media and readable and executable by a computer such as a vehicle control device to execute the instructions.

According to (1) to (12), information according to a state of the vehicle may be provided.

### BRIEF DESCRIPTION OF THE DRAWINGS

FIG. 1 is a configuration diagram of a vehicle control system including a display system according to an embodiment.

FIG. 2 illustrates the manner in which the relative position and posture of a vehicle with respect to a driving lane are recognized by a vehicle position recognizer.

FIG. 3 illustrates the manner in which a target course is generated based on a recommended lane.

FIG. 4 is a perspective view for explaining a display device retainer provided in a vehicle cabin.

FIG. 5 is a view illustrating a configuration example of the display device retainer.

FIG. 6 is a view for explaining the manner in which the display device retainer retains a display device.

FIG. 7 is a perspective view for explaining an exposure amount of a display screen at the time of manual driving.

FIG. 8 is a perspective view for explaining an exposure amount of a display screen at the time of automatic driving.

FIG. 9 is a perspective view for explaining an example of display contents of the display device at the time of manual driving.

FIG. 10 is a perspective view for explaining an example of display contents of the display device at the time of automatic driving.

FIG. 11 is a view for explaining an example of display contents of the display device detached from the display device retainer.

FIG. 12 is a perspective view illustrating an example of the display device retainer from which the display device has been detached.

FIG. 13 is a flowchart illustrating an example of the display system according to the embodiment.

FIG. 14 is a perspective view illustrating an example of a center console provided with a display device retainer.

FIG. 15 is a view for explaining the retention state of the display device in the display device retainer at the time of manual driving.

FIG. 16 is a view for explaining the retention state of the display device in the display device retainer at the time of automatic driving.

FIG. 17 is a view for explaining the manner in which a seat is raised in the display device retainer.

### DESCRIPTION OF THE PREFERRED EMBODIMENTS

Hereinafter, an embodiment of a display system, a display method, and a program of the present disclosure will be described with reference to the drawings. In the embodiment, the display system is to be applied to an automatic driving vehicle. The automatic driving refers to controlling one or both of steering and acceleration/deceleration of a vehicle without an operation of an occupant of the vehicle, for instance.

### Entire Configuration

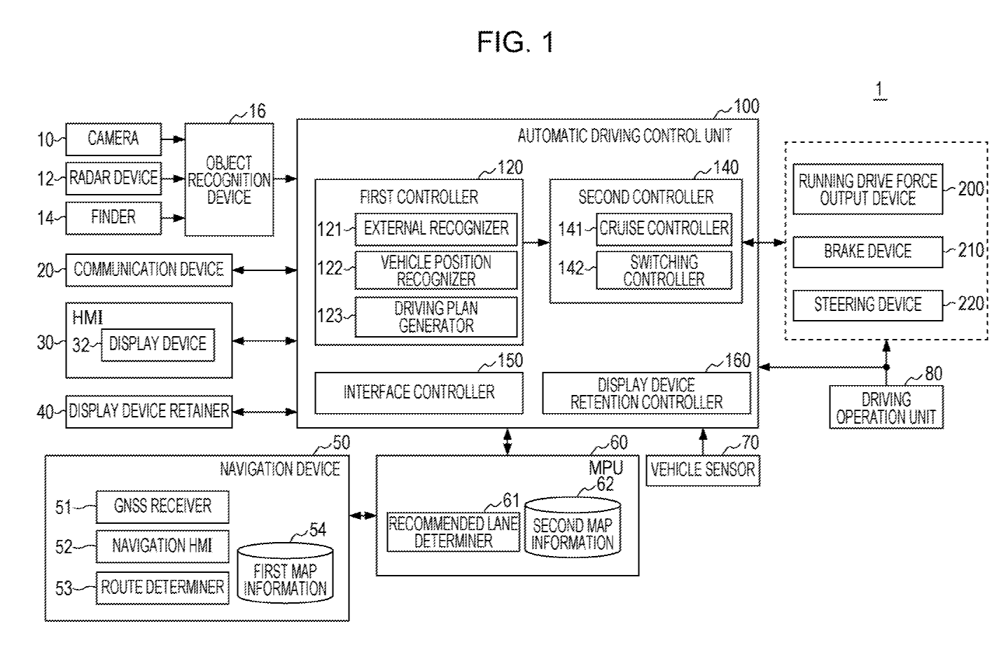

FIG. 1 is a configuration diagram of a vehicle control system including a display system according to an embodiment. A vehicle in which the vehicle control system 1 is mounted (hereinafter referred to as a vehicle M) is, for instance, a vehicle such as a two-wheel vehicle, a three-wheel vehicle, and a four-wheel vehicle, and the drive source is an internal-combustion engine, such as a diesel engine and a gasoline engine, an electric motor, and a combination of these. The electric motor operates using the power generated by a motor connected to an internal-combustion engine or discharge power of a secondary battery or a fuel cell.

The vehicle control system 1 includes, for instance, a camera 10, a radar device 12, a finder 14, an object recognition device 16, a communication device 20, and a human machine interface (HMI) 30, a display device retainer 40, a navigation device 50, a micro-processing unit (MPU) 60, a vehicle sensor 70, a driving operation unit 80, an automatic driving control unit 100, a running drive force output device 200, a brake device 210, and a steering device 220. These devices and equipment are connected to each other via a multi-channel communication line or a serial communication line, such as a controller area network (CAN) communication line, or a wireless communication network. It is to be noted that the configuration illustrated in FIG. 1 is merely an example, and part of the configuration may be omitted, or still another configuration may be added. Also, a display device 32 is an example of the “display”. Also, when the display device retainer 40 and the display device retention controller 160 are combined together, the combined entity is an example of the “retainer”.

The camera 10 is, for instance, a digital camera utilizing a solid-state image sensing device, such as a charge coupled device (CCD) and a complementary metal oxide semiconductor (CMOS). One or more cameras 10 are installed in any position of the vehicle M in which the vehicle control system 1 is mounted. When the front is to be captured, the camera 10 is installed in an upper portion of the front windshield or the back side of a rearviev mirror. When the rear is to be captured, the camera 10 is installed in an upper portion of the rear windshield or a rear door. When the side is to be captured, the camera 10 is installed in a door mirror. The camera 10 periodically captures the surroundings of the vehicle M repeatedly, for instance. The camera 10 may be a stereo camera.

The radar device 12 emits radio waves such as millimeter waves to the surroundings of the vehicle M as well as detects radio waves reflected by an object (reflection waves), and detects at least the position (distance and azimuth) of the object. One or more radar devices 12 are installed in any position of the vehicle M. The radar device 12 may detect the position and velocity of an object by the Frequency Modulated Continuous Wave (FMCW) system.

The finder 14 uses Light Detection and Ranging or Laser Imaging Detection and Ranging (LIDAR) that measures scattered light for irradiation light, and detects a distance to an object. One or more finders 14 are installed in any position of the vehicle M.

The object recognition device 16 performs sensor fusion processing on detection results obtained by part or all of the cameras 10, the radar devices 12, and the finders 14, and recognizes the position, the type, and the velocity of the object. The object recognition device 16 outputs recognition results to the automatic driving control unit 100.

The communication device 20 communicates with other vehicles present around the vehicle M or with various server devices via a wireless base station utilizing, for instance, a cellular network or a Wi-Fi network, Bluetooth (registered trademark), or Dedicated Short Range Communication (DSRC). In addition, the communication device 20 communicates with the terminal device possessed by a person outside the vehicle.

The HMI 30 presents various types of information to an occupant of the vehicle M, and receives an input operation by an occupant. The HMI 30 includes the display device 32, for instance. The display device 32 is a liquid crystal display (LCD), or an organic electro luminescence (EL) display device. Alternatively, the display device 32 may be a touch-screen display device that can detect contact with a display area for images. In this case, a predetermined position of the display is touched by a fingertip of an occupant or a touch pen, and the display device 32 thereby receives a selection operation and a confirmation operation performed by an occupant.

Also, the display device 32 is, for instance, a tablet terminal which is retained by the display device retainer 40. In the display device 32, application programs (software) for displaying images for in-vehicle equipment (for instance, air-conditioning equipment, an audio instrument, a DVD player, a TV program viewing-and-listening device, a navigation device 50) are installed in coordination with the automatic driving control unit 100, and display in this embodiment is achieved by executing the installed application programs. For instance, the display device 32 is connected to the vehicle M by wireless communication such as a Wi-Fi network, Bluetooth, and receives from the vehicle M temperature setting in air-conditioning equipment such as an air-conditioner, and other vehicle information operable by the display device 32, as well as transmits the information operated by the display device 32 to the vehicle M. Thus, in a state where the display device 32 is detached from the display device retainer 40, it is possible to operate the in-vehicle equipment via the display device 32. The details of display contents of the display device 32 will be described later.

Also, the HMI 30 includes various display devices such as a display device installed in the instrument panel and a head up display (HUD), a microphone, a loudspeaker, a buzzer, a switch, and a key.

The display device retainer 40 retains the display device 32 at multiple retention positions with different exposure amounts of the display device 32 at a predetermined location in the vehicle cabin. The predetermined location is, for instance, a center console. Alternatively, the predetermined location may be an instrument panel or the roof (ceiling of the vehicle cabin). The exposure amount is, for instance, an exposure amount with respect to the display screen which displays an image. Alternatively, the exposure amount may be an exposure amount with respect to the entire face provided with a display screen among the faces of the display device 32.

Also, the display device retainer 40 retains the display device 32 at a retention position according to a state of the vehicle M. The state of the vehicle M is, for instance, a driving state such as a state where the vehicle M is in manual drive or a state where the vehicle M is in automatic drive. Alternatively, the state of the vehicle M may be a state of the running speed of the vehicle M. Also, the display device retainer 40 retains the display device 32 in a state where the display device 32 is detachable from a predetermined location or in a state where the display device 32 is non-detachable from a predetermined location, according to a state of the vehicle M. The details of the function of the display device retainer 40 will be described later.

The navigation device 50 includes, for instance, a global navigation satellite system (GNSS) receiver 51, a navigation HM 152, and a route determiner 53, and holds first map information 54 in a storage device, such as a hard disk drive (HDD) or a flash memory. The GNSS receiver identifies the position of the vehicle M based on signals received from GNSS satellites. The position of the vehicle M may be identified or complemented by an inertial navigation system (INS) utilizing the output of the vehicle sensor 70. The navigation HM 152 includes a display device, a loudspeaker, a touch panel, and a key. The route determiner 53 determines, for instance, a route (including, for instance, information on points on the route to a destination) from the position of the vehicle M identified by the GNSS receiver 51 (or any inputted position) to a destination inputted by an occupant using the navigation HM 152 by referring to the first map information 54. The first map information 54 is information that represents a road geometry by links each of which indicates a road, and nodes each of which is connected by links. The first map information 54 may include a curvature of a road and point of interest (POI) information. A route determined by the route determiner 53 is outputted to the MPU 60. Also, the navigation device 50 may guide a route using the navigation HM 152 based on the route determined by the route determiner 53. It is to be noted that the navigation device 50 may be implemented, for instance, by the function of a terminal device, such as a smartphone or a tablet terminal, possessed by a user. Also, the navigation device 50 may transmit the current position and a destination to a navigation server via the communication device 20, and may obtain a route sent back from the navigation server.

The MPU 60 serves as a recommended lane determiner 61, for instance, and holds second map information 62 in a storage device such as a HDD or a flash memory. The recommended lane determiner 61 divides the route provided by the navigation device 50 into multiple blocks (for instance, divides the route every 100 [m] in a traveling direction of the vehicle), and determines a recommended lane for each block by referring to the second map information 62. The recommended lane determiner 61 determines an ordinal number of the lane from the left. When a branch point or a merge point is present on a route, the recommended lane determiner 61 determines a recommended lane so that the vehicle M can travel along a reasonable route to reach a branch point.

The second map information 62 is map information which is higher in accuracy than the first map information 54. The second map information 62 includes information on the center of a lane and information on a boundary between lanes, for instance. Also, the second map information 62 may include traffic information, traffic restriction information, address information (address and zip code), facility information, and telephone number information. The traffic information includes information indicating the type of a road, such as a highway, a toll road, a national road, and a prefectural road, and information such as the number of lanes of a road, the area of an emergency parking bay, the width of each lane, the slope of a road, the position of a road (three-dimensional coordinates including a longitude, a latitude, and a height), the curvature of a curve of a lane, the positions of merge and branch points of a lane, and signs installed on a road. The second map information 62 may be updated as needed by accessing other devices using the communication device 20.

The vehicle sensor 70 includes a vehicle speed sensor that detects a speed of the vehicle M at the present, an acceleration sensor that detects an acceleration of the vehicle M in a traveling direction, a yaw rate sensor that detects an angular speed around the vertical axis, and an orientation sensor that detects an orientation of the vehicle M. The acceleration includes, for instance, at least one of a longitudinal acceleration in a traveling direction of the vehicle M and a lateral acceleration in a lateral direction of the vehicle M. The vehicle sensor 70 outputs detected information (such as a speed, an acceleration, an angular speed, and an azimuth) to the automatic driving control unit 100.

The driving operation unit 80 includes, for instance, an accelerator pedal, a brake pedal, a shift lever, a steering wheel, and other driving operation units. A sensor which detects an amount of operation or the presence of an operation is mounted on the driving operation unit 80, and a detection result is outputted to one or both of the automatic driving control unit 100, and the running drive force output device 200, the brake device 210, the steering device 220.

### Automatic Driving Control Unit

The automatic driving control unit 100 includes, for instance, a first controller 120, a second controller 140, an interface controller 150, and a display device retention controller 160. These components are implemented, for instance, by a hardware processor such as a central processing unit (CPU) executing a program (software). Alternatively, part or all of these components may be implemented by hardware (including circuitry) such as Large Scale Integration (LSI), an application specific integrated circuit (ASIC), a field-programmable gate array (FPGA), and a graphics processing unit (GPU), or implemented by cooperation of software and hardware. Alternatively, these components may be implemented by a single processor or implemented by multiple processors. In the latter case, the automatic driving control unit 100 may be, for instance, a system in which multiple electronic control units (ECU) are combined. Also, when the first control unit 120 and the second control unit 140 are combined together, the combined entity is an example of the “automatic driving control unit”. Also, the interface controller 150 is an example of the “display controller”.

The first control unit 120 includes, for instance, an external recognizer 121, a vehicle position recognizer 122, and a driving plan generator 123.

The external recognizer 121 recognizes the state of a vehicle in the surroundings, such as the position, speed, and acceleration, of the vehicle based on information inputted from the camera 10, the radar device 12, and the finder 14 via the object recognition device 16. The position of a vehicle in the surroundings may be indicated by a representative point such as the centroid or a corner of the vehicle, or an area indicated by the outline of the vehicle. The “state” of a vehicle in the surroundings may include the acceleration and jerk of the vehicle, or a “driving state” (for instance, the vehicle is changing the lane, or whether or not the vehicle is about to change the lane) of the vehicle.

In addition to the position of a vehicle in the surroundings, the external recognizer 121 may recognize the positions of a guardrail or a utility pole, a parking vehicle, a person such as a pedestrian, and other objects.

The vehicle position recognizer 122 recognizes, for instance, a lane (driving lane) alone which the vehicle M is running, and the relative position and posture of the vehicle M with respect to the driving lane. The vehicle position recognizer 122 recognizes a driving lane, for instance, by comparing a pattern of road division lines (for instance, arrangement of solid lines and dashed lines) obtained from the second map information 62 with a pattern of road division lines in the surroundings of the vehicle M, recognized from images captured by the camera 10. In the recognition, the position of the vehicle M obtained from the navigation device 50 and a result of processing performed by INS may be considered.

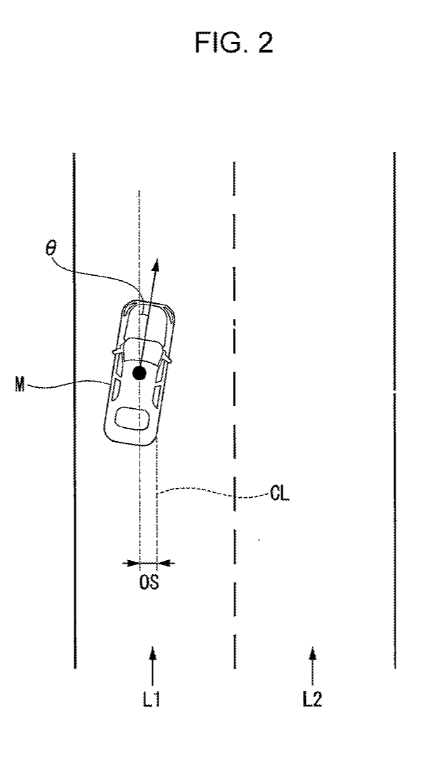

The vehicle position recognizer 122 then recognizes, for instance, the position and posture of the vehicle M relative to the driving lane. FIG. 2 illustrates the manner in which the relative position and posture of the vehicle M with respect to a driving lane L1 are recognized by the vehicle position recognizer 122. The vehicle position recognizer 122 recognizes, for instance, a deviation OS of a reference point (for instance, the centroid) of the vehicle M from a driving lane center CL, and angle θ of the traveling direction of the vehicle M with respect to the driving lane center CL as the relative position and posture of the vehicle M with respect to the driving lane L1. Alternatively, the vehicle position recognizer 122 may recognize the position of a reference point of the vehicle M relative to one of the lateral ends of the driving lane L1 as the relative position of the vehicle M with respect to the driving lane. The relative position of the vehicle M recognized by the vehicle position recognizer 122 is provided to the recommended lane determiner 61 and the driving plan generator 123.

The driving plan generator 123 generates a driving plan for the vehicle M to perform automatic driving to a destination. For instance, the driving plan generator 123 determines events to be sequentially executed in automatic driving control so that the vehicle M runs along the recommended lane determined by the recommended lane determiner 61 and addresses the surrounding conditions of the vehicle M. The events in the automatic driving of the first embodiment include, for instance, a constant speed running event in which the vehicle M runs along the same driving lane at a constant speed, a lane change event in which the driving lane of the vehicle M is changed, a passing event in which the leading vehicle is passed, a following drive event in which the vehicle M follows the leading vehicle, a merge event in which the vehicle M is merged at a merge point, a branch event in which the vehicle M is caused to travel in a direction to a destination at a branch point of a road, an emergency stop event in which the vehicle M is caused to stop, and a switching event in which automatic driving is ended and switched to manual driving. Also, during execution of these events, action for avoidance may be planned based on the surrounding conditions of the vehicle M (such as the presence of a vehicle in the surroundings and a pedestrian, a narrowed lane due to road construction).

The driving plan generator 123 generates a target course along which the vehicle M runs in the near future. The target course includes a speed component, for instance. For instance, multiple reference times in the near future are set at predetermined sampling times (for instance, on the order of zero point several seconds), and the target course is generated as a set of target points (course points) to be reached at those reference times. Therefore, wide space between course points indicates that the vehicle runs at a higher speed through the interval between the course points.

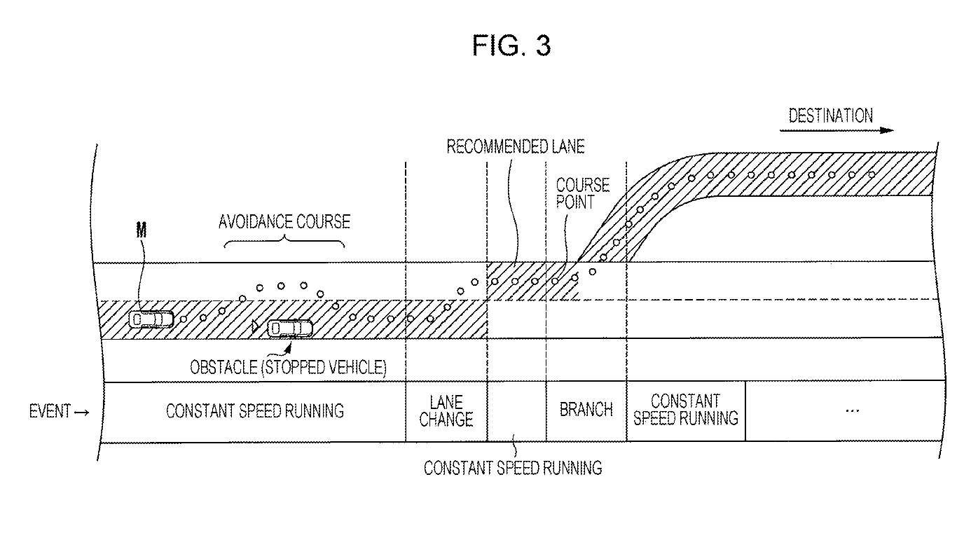

FIG. 3 illustrates the manner in which a target course is generated based on the recommended lane. As illustrated, a recommended lane is made convenient for the vehicle to run along the route to a destination. When the vehicle is at a predetermine distance (may be determined according to the type of an event) before a switch point of a recommended lane, the driving plan generator 123 starts a lane change event, a branch event, or a merge event. When an obstacle needs to be avoided during execution of the events, an avoidance course is generated as illustrated.

The driving plan generator 123 generates, for instance, multiple candidates for a target course, and selects an optimal target course adapted to the route to a destination at that time based on the point of view of safety and efficiency. Also, for instance, when the vehicle M is in automatic driving and the driving operation unit 80 is unable to be operated, the driving plan generator 123 changes the target course based on the contents of instruction from an occupant received by an alternative operation receiving interface.

The second control unit 140 includes, for instance, a cruise controller 141 and a switching controller 142. The cruise controller 141 controls the running drive force output device 200, the brake device 210, and the steering device 220 so that the vehicle M drives along a target route generated by the driving plan generator 123 as scheduled.

The switching controller 142 switches between the driving modes of the vehicle M based on the driving plan generated by the driving plan generator 123. For instance, the switching controller 142 switches the driving mode from manual drive to automatic drive at a scheduled start point. Also, the switching controller 142 switches the driving mode from automatic drive to manual drive at a scheduled end point.

At the time of manual drive, input information from the driving operation unit 80 is outputted to the running drive force output device 200, the brake device 210, and the steering device 220. Alternatively, the input information from the driving operation unit 80 may be outputted to the running drive force output device 200, the brake device 210, and the steering device 220 via the automatic driving control unit 100. An electronic control unit (ECU) of each of the running drive force output device 200, the brake device 210, and the steering device 220 performs an operation based on the input information from the driving operation unit 80.

The interface controller 150 causes the HMI 30 to output notification or the like related to a running state of the vehicle M at the time of automatic driving or manual driving, the timing of switching between automatic driving and manual driving, and a request of a driver to manually drive. Also, the interface controller 150 generates an image in which the content is complete, by an exposed portion (exposed surface) of the display of the display device 32 according to the state of the vehicle M, and displays the generated image on the exposed surface of the display device 32. The details of the function of the interface controller 150 will be described later.

The display device retention controller 160 controls the retention state of the display device 32 in the display device retainer 40 according to the state of the vehicle M. The “controlling the retention state” refers to, for instance, controlling the retention state so that the exposed surface of the display device 32 is changed. Also, the “controlling the retention state” refers to controlling the retention state so that in a state where the display device 32 is detachable from the display device retainer 40 or in a state where the display device 32 is non-detachable from the display device retainer 40. The details of the function of the display device retention controller 160 will be described later.

The running drive force output device 200 outputs a running drive force (torque) for the vehicle M to the driving wheels. The running drive force output device 200 includes, for instance, a combination of an internal-combustion engine, an electric motor, and a transmission, and an ECU that controls these. The ECU controls the above-mentioned configuration in accordance with the information inputted from the cruise controller 141 or the information inputted from the driving operation unit 80.

The brake device 210 includes, for instance, a brake caliper, a cylinder that transmits a hydraulic pressure to the brake caliper, an electric motor that causes the cylinder to generate a hydraulic pressure, and a brake ECU. The brake ECU controls the electric motor in accordance with the information inputted from the cruise controller 141 or the information inputted from the driving operation unit 80, and outputs a brake torque according to a brake operation to each wheel. The brake device 210 may include a mechanism, as a backup, which transmits a hydraulic pressure to a cylinder via a master cylinder, the hydraulic pressure being generated by an operation of the brake pedal included in the driving operation unit 80. The brake device 210 is not limited to the above-described configuration, and may be an electronic controlled hydraulic brake device that controls an actuator in accordance with the information inputted from the cruise controller 141 or the information inputted from the driving operation unit 80, and transmits a hydraulic pressure of a master cylinder to a cylinder. Also, the brake device 210 may include brake devices in multiple systems in consideration of safety.

The steering device 220 includes, for instance, a steering ECU, and an electric motor. The electric motor applies a force to a rack and pinion mechanism, for instance, and changes the direction of a turning wheel. The steering ECU drives the electric motor in accordance with the information inputted from the cruise controller 141 or the information inputted from the driving operation unit 80, and changes the direction of a turning wheel.

### Retention State of Display Device 32 and Image Display According to Retention State

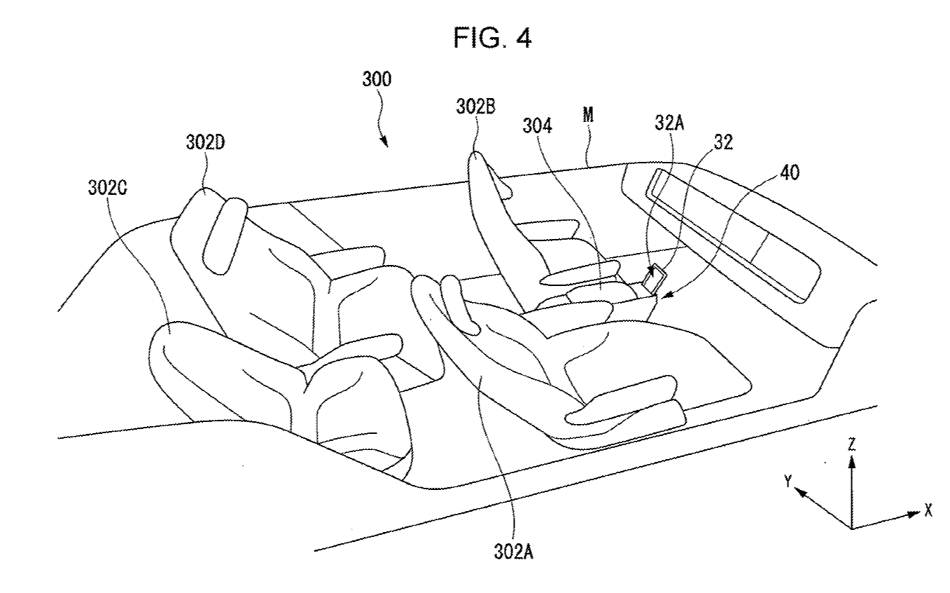

Next, the retention state of the display device 32 in the display device retainer 40, and an example of image display according to the retention state will be specifically described. FIG. 4 is a perspective view for explaining the display device retainer 40 provided in a vehicle cabin. FIG. 4 illustrates seats 302A to 302D and a center console 304 in a vehicle cabin 300. It is to be noted that in FIG. 4, illustration of the driving operation unit such as the steering wheel, the accelerator pedal, and the brake pedal is omitted.

The seat 302A to 302D are seats on which occupants of the vehicle M sit. Hereinafter, description is given where let the seat 302A be the driver seat on which an occupant sits, who manually drives the vehicle M, the seat 302B be the front passenger seat, and the seats 302C and 302D be the rear seats.

The center console 304 is provided, for instance, between the seat 302A and the seat 302B. The display device retainer 40 is provided in the center console 304.

The display device retainer 40 is retained at a position at which the display screen of the display device 32 can be visually recognized from the respective occupants who sit down on the driver seat and the front passenger seat, for instance. Also, the display device retainer 40 changes the degree of an exposed surface 32Aa according to a state of the vehicle M.

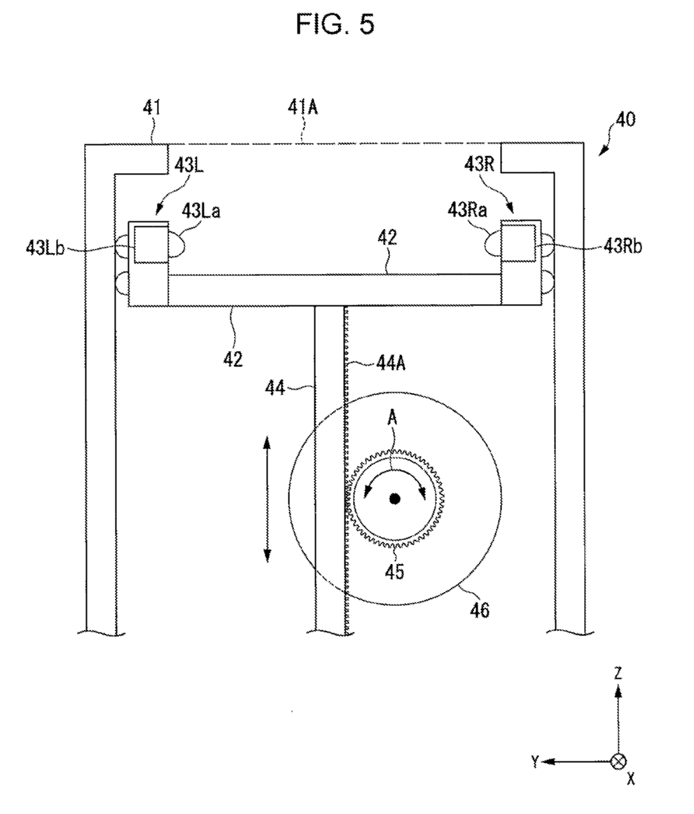

FIG. 5 is a view illustrating a configuration example of the display device retainer 40. The example of FIG. 5 illustrates a sectional view along Y2 plane of the display device retainer 40. The display device retainer 40 in FIG. 5 illustrates, for instance, a housing 41, a seat 42, fixed, portions 43, a hoisting and lowering shaft 44, a gear 45, and a driver 46.

The housing 41 stores the seat 42, the fixed portions 43, the hoisting and lowering shaft 44, the gear 45, and the driver 46. Also, the housing 41 stores at least part of the display device 32, fixed by the fixed portions 43. The seat 42 supports the display device 32 from below, which is inserted in a downward direction (−Z direction) through an opening 41A of the housing 41.

The fixed portions 43 fix the display device 32 placed on the seat 42. In the example illustrated, grippers 43L and 43R are provided as the fixed portions 43 on the right and left of the seat 42. A gripper 43L includes, for instance, a projection 43La and a projection controller 43Lb. Also, the gripper 43R includes, for instance, a projection 43Ra and a projection controller 43Rb. The projection controllers 43Lb and 43Rb drives the projections 43La and 43Ra and grasps the right and left of the display device 32 based on a control signal inputted from the display device retention controller 160, thereby fixing the display device 32 on the seat 42. Also, a roller may be provided in the lateral surface of each of the fixed portions 43. The roller is in contact the inner surface of the housing 41, and rotates along with the hoisting and lowering of the seat 42.

The hoisting and lowering shaft 44 is installed at a lower portion of the seat 42. In the hoisting and lowering shaft 44, for instance, multiple projections 44A are formed at predetermined intervals so as to be engaged with the projections of the gear 45. Therefore, the hoisting and lowering shaft 44 causes the seat 42 to hoist and lower (move in ±Z direction) by driving the gear 45. Alternatively, instead of the projections 44A, grooves may be formed in the hoisting and lowering shaft 44.

In the gear 45, projections are formed so as to be engaged with the projections 44A of the hoisting and lowering shaft 44. The gear 45 rotates in the directions of arrow A in FIG. 5 around a predetermined axis by the operation of the driver 46.

The driver 46 is a motor that operates by the control of the display device retention controller 160. The rotor of a motor is connected to the gear 45.

In this embodiment, the roller provided in the lateral surface of each of the fixed portions 43 may be inserted in a slide rail (not illustrated) which is provided in each of the inner surfaces of the housing 41 and extends in the hoisting and lowering direction. Consequently, the seat 42 can be moved in a vertical direction along the slide rail, and thus wobble at the time of hoisting and lowering can be reduced.

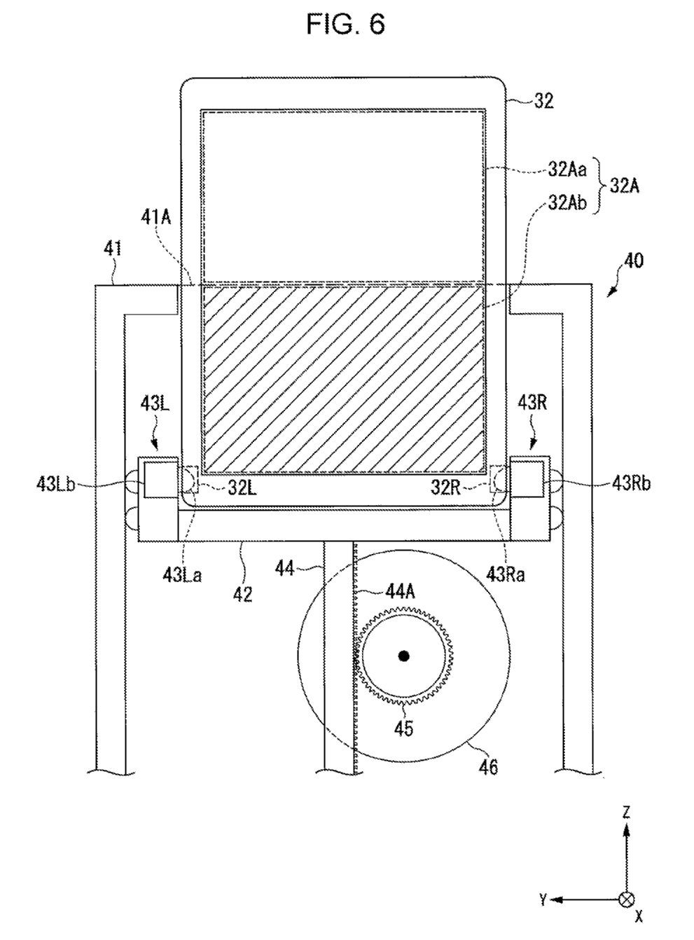

FIG. 6 is a view for explaining the manner in which the display device retainer 40 retains the display device 32. The display device retention controller 160 controls the drive of the driver 46 so that the seat 42 is stopped at a predetermined position according to a state of the vehicle M. When the up and down position of the seat 42 is changed by the operation of a motor driven by the driver 46, the exposed surface of the display device 32 is also changed accordingly. 32Aa in FIG. 6 indicates the exposed surface of the display screen 32A, and 32Ab in FIG. 6 indicates the shield face (unexposed surface) of the display screen 32A.

For instance, the display device retention controller 160 determines whether the vehicle M is in automatic drive or manual drive by the first controller 120 and the second controller 140, and changes the size of the exposed surface based on a determination result.

When it is determined that the vehicle M is in manual drive, the display device retention controller 160 drives the driver 46 to move the seat 42 to a position according to the manual drive.

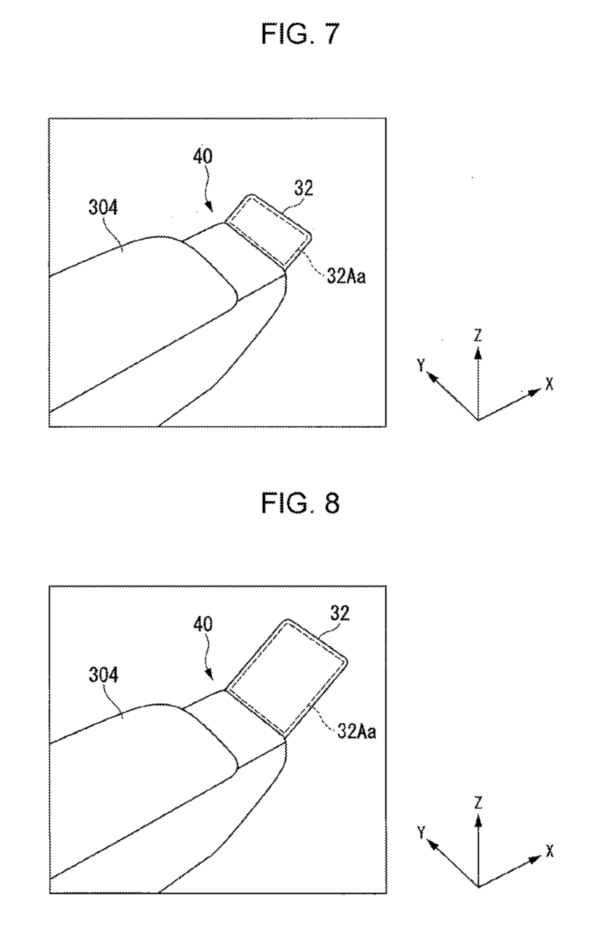

FIG. 7 is a perspective view for explaining an exposure amount of the display screen at the time of manual driving. When the vehicle M is in manual drive, the display device retention controller 160 controls the display device retainer 40 so that the exposure amount of the exposed surface 32Aa is displayed with a first exposure amount according to the manual drive.

In addition, at the time of manual driving, the display device retention controller 160 controls the display device retainer 40 so that the display device 32 may be detached from the display device retainer 40. For instance, at the time of manual driving, the display device retention controller 160 controls the projection controllers 43Lb and 43Rb so that the projections 43La and 43Ra project and are inserted into grooves 32L and 32R provided on the right and left of the display device 32. Consequently, the display device 32 is fixed in a state where the display device 32 is non-detachable from the display device retainer 40.

Also, when it is determined that the vehicle M is in automatic drive, the display device retention controller 160 causes the driver 46 to drive the seat 42 so that the seat 42 is moved to a position according to the automatic drive.

FIG. 8 is a perspective view for explaining an exposure amount of the display screen at the time of automatic driving. When the vehicle M is in automatic drive, the display device retention controller 160 controls the display device retainer 40 so that the exposure amount of the exposed surface 32Aa is displayed with a second exposure amount according to the automatic drive. For instance, the display device retention controller 160 changes the retention position of the display device 32 retained by the display device retainer 40 so that the second exposure amount is greater than the first exposure amount.

For instance, the display device retention controller 160 changes the retention position so that the height of the upper end of the display device 32 is varied between the time of automatic driving and the time manual driving. The height of the upper end of the display device 32 is the height of the uppermost position in the vertical direction of the vehicle M, that is, the height of the uppermost position in the up and down direction. In this case, the height of the upper end of the display device 32 at the time of automatic driving is higher than the height of the upper end of the display device 32 at the time of manual driving. The limited space in the vehicle cabin 300 can be effectively used by changing the retention position in the height direction in this manner. Since the display device retainer 40 is provided in the center console 304, even when the retention position of the display device 32 is raised, the field of view of other displays is not prevented.

The interface controller 150 retains the retention position of the display device retainer 40 according to a state of the vehicle M by the display device retention controller 160, and causes the display device 32 to display an image in which the content is complete, by an exposed portion of the display device 32.

FIG. 3 is a perspective view for explaining an example of display contents of the display device 32 at the time of manual driving. The display contents and the layout of the display device 32 described below are not limited to this example. The interface controller 150 displays information on in-vehicle equipment on the exposed surface 32Aa of the display device 32. The information on in-vehicle equipment is information for operating the function of the in-vehicle equipment, for instance. Specifically, information on air-conditioning (for instance, temperature setting in the vehicle cabin, setting of vents for air flow, setting of direction of the vents), information on audio (for instance, song selection setting, sound volume setting), information on window defogging device such as a defroster and a defogger (for instance, ON/OFF setting), information on state setting of automatic drive/manual drive of the vehicle M (for instance, switching setting), and information displayed by the navigation HM 152 of the navigation device 50. These pieces of information are displayed, for instance, by a graphical user interface (GUI) image such as an icon and a slide bar for operating by contact with the display area of the display device 32.

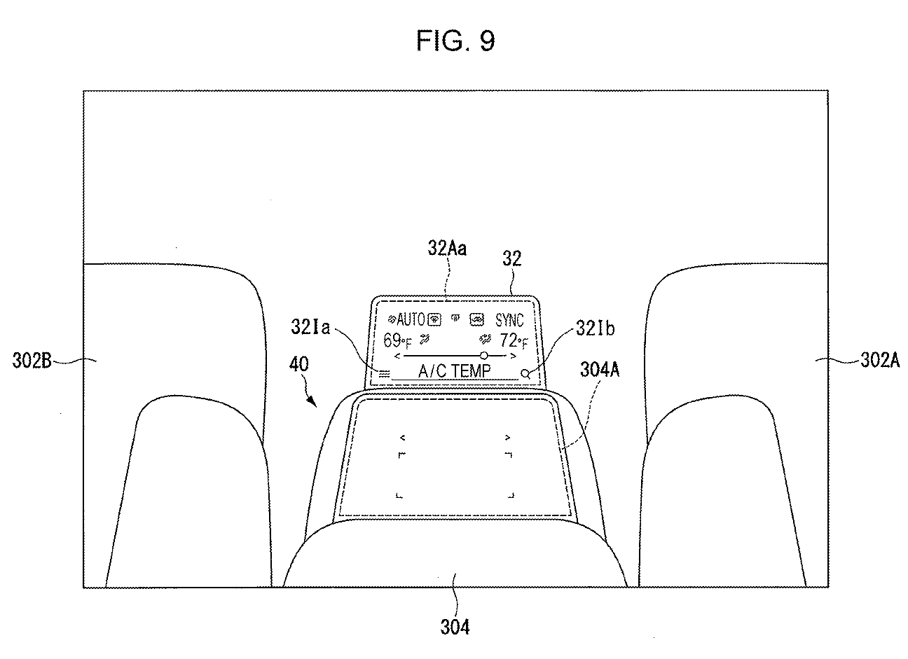

In the example of FIG. 9, images indicating a vehicle cabin temperature, a preset temperature, a temperature setting bar, air volume setting, and vents for air flow are displayed as an operation screen for operating the function of air-conditioning on the exposed surface 32Aa of the display device 32. When an occupant touches a position on the temperature setting bar displayed on the screen, a vehicle cabin temperature corresponding to the touched position is set. Like this, at the time of manual driving, the exposed surface of the display device 32 is reduced, and partial information (for instance, information on the in-vehicle equipment) among the information displayable by the display device 32 is displayed, thereby making it possible to avoid distraction of attention (what is called driver distraction) which is caused by activities other than driving (for instance, an operation of the display device 32) of an occupant (particularly the driver).

It is to be noted that as illustrated, the interface controller 150 may display on the exposed surface 32Aa of the display device 32 an image 32Ia of selection menu buttons for selecting contents to be displayed, and an image 32Ib of a search button for communicating with an external web server and the like by the communication device 20, and searching for an inputted string. For instance, when an occupant touches the display position of the image 32Ia of selection menu buttons, the interface controller 150 displays an item list of the in-vehicle equipment displayable on the exposed surface 32Aa. When an occupant selects one in the displayed list of the in-vehicle equipment, information on a corresponding one of the in-vehicle equipment is displayed on the exposed surface. Also, when an occupant touches the display position of the image 32Ib of a search button, the interface controller 150 displays an input button for inputting a string and a text input area on the exposed surface 32Aa. The interface controller 150 then performs search in a predetermine web server based on a keyword inputted in the text input area by the input button, and displays a search result on the exposed surface 32Aa.

In the embodiment, as illustrated in FIG. 9, a display 304A may also be provided in the center console 304. In this case, the interface controller 150 may display on the display 304A an image with contents associated with the display contents of the exposed surface 32Aa of the display device 32. For instance, when the display position of the image 32Ia of selection menu buttons is touched, the interface controller 150 may display a displayable item list of in-vehicle equipment on the display 304A. Consequently, other information can be presented to occupants while the display contents of the exposed surface 32Aa are being maintained.

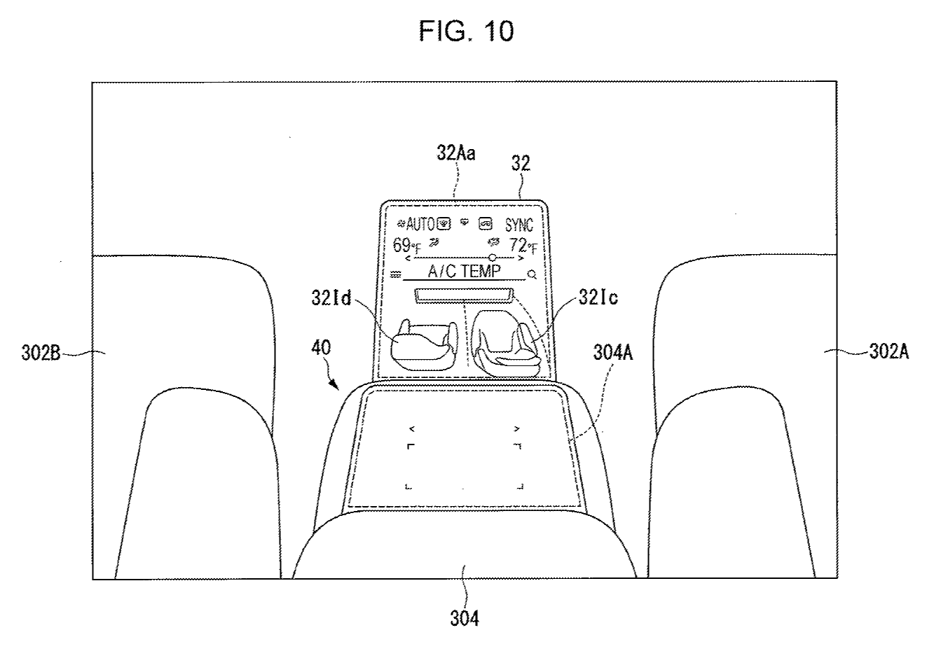

FIG. 10 is a perspective view for explaining an example of display contents of the display device 32 at the time of automatic driving. As described above, at the time of automatic driving, the exposed surface 32Aa is enlarged than at the time of manual driving. Therefore, the interface controller 150 can display detailed information on the in-vehicle equipment or multiple pieces of information on the in-vehicle equipment on the exposed surface 32Aa of the display device 32.

In the example of FIG. 10, an image 32Ic of the driver seat 302A and an image 32Id of the passenger seat 302B are displayed as detailed information on air-conditioning on the exposed surface 32Aa of the display device 32. For instance, when an occupant touches the display position of one of the image 32Ic and the image 32Id, the interface controller 150 displays an image of air flow to the selected seat as well as receives air-conditioning setting for the selected seat. Thus, an occupant can easily recognize setting to be made intuitively by displaying detailed information in this manner. In addition, the interface controller 150 may display on the display 304A an image with contents associated with the display contents of the exposed surface 32Aa.

Also, when the vehicle M is in automatic drive, the display device retention controller 160 controls the projection controllers 43Lb and 43Rb so that the display device 32 is detachable from the display device retainer 40, and moves the projections 43La and 43Ra inserted in the grooves 32L and 32R of the display device 32 to a position out from the grooves 32L and 32R. Consequently, the display device 32 is supported by the seat 42, the lateral surfaces of the fixed portions 43, and the housing 41, and thus an occupant can detach the display device 32 from the display device retainer 40. Thus, an occupant can operate the display device 32 near at hand and can view the contents displayed on the display device 32.

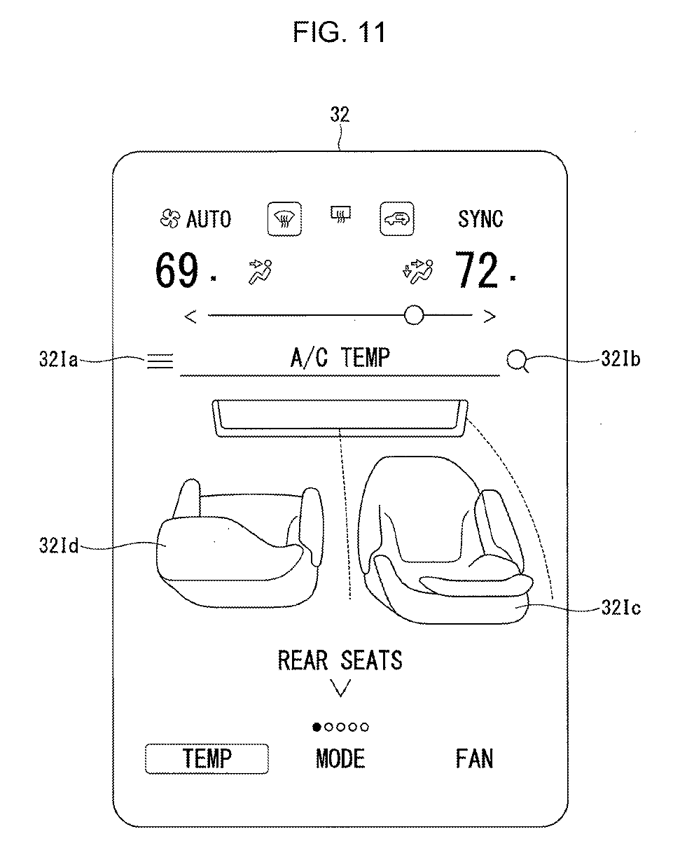

FIG. 11 is a view for explaining an example of display contents of the display device 32 detached from the display device retainer 40. In the example of FIG. 11, information on air-conditioning equipment, the image 32Ia of selection menu buttons, the image 32Ib of search button, the image 32Ic of the driver seat 302A, and the image 32Id of the passenger seat 302B are displayed. When the display device 32 is detached from the display device retainer 40, the interface controller 150 displays more detailed contents than the display contents of the display device 32 when retained by the display device retainer 40. For determination as to whether or not the display device 32 is detached from the display device retainer 40, for instance, an object detection sensor is provided in the opening 41A, and when an object is not detected by the object detection sensor, the interface controller 150 determines that the display device 32 has been detached from the display device retainer 40. Alternatively, a weight sensor is provided in the seat 42, and when a weight detected by the weight sensor is less than or equal to a threshold, the interface controller 150 may determine that the display device 32 has been detached from the display device retainer 40.

For instance, when an occupant performs a swipe operation from the upper side to the lower side on the screen of the display device 32 detached from the display device retainer 40, the interface controller 150 displays an air-conditioning setting screen for the rear seats 302C and 302D. Also, when an occupant performs a swipe operation in the horizontal direction of the screen, information on equipment, other than the air-conditioner may be displayed on the screen. Alternatively, the interface controller 150 may display multimedia contents, such as a content reproduction screen such as a DVD and a display screen of a TV program, on the display device 32. Like this, in the embodiment, the display device 32 can be detached and placed near at hand at the time of automatic driving, even at a position away from the driver seat or the front passenger seat, various types of setting for the in-vehicle equipment and content display can be made.

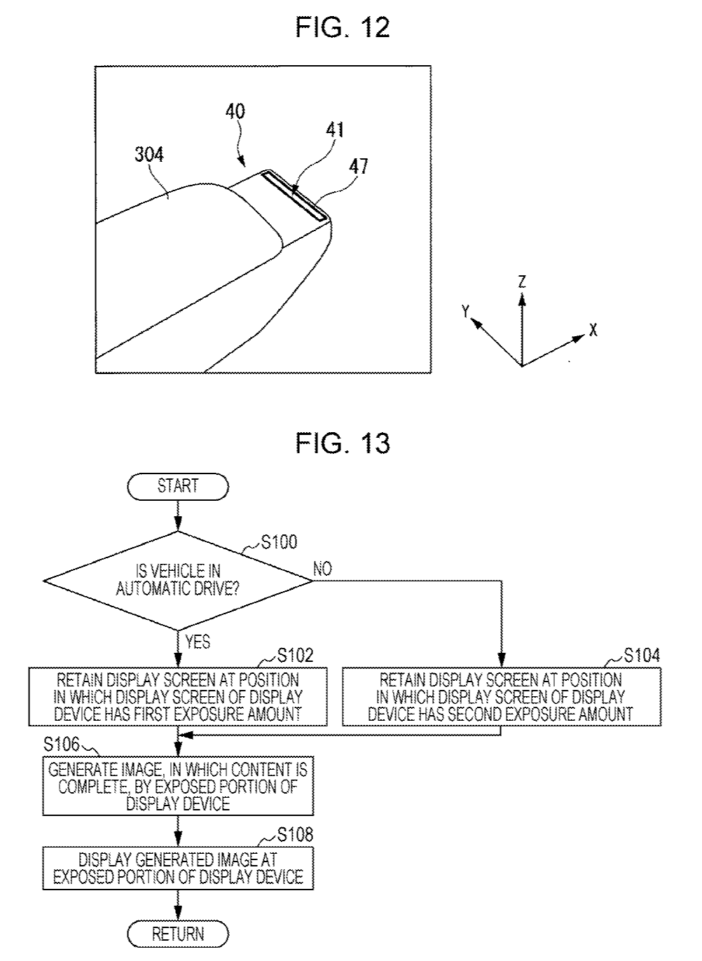

FIG. 12 is a perspective view illustrating an example of the display device retainer 40 from which the display device has been detached. As illustrated, the display device retainer 40 may be provided with an indicator 47 near the opening 41A of the housing 41. Near the opening indicates a range within a predetermined distance relative to the opening 41A. Although the indicator 47 is provided in the surroundings of the opening 41A in the example illustrated, for instance, the indicator 47 may be provided along at least one side of the rectangular opening 41A.

For instance, at the time when the display device 32 is detached from the display device retainer 40, the interface controller 150 lights on the indicator 47 with a predetermined color. The predetermined color is a color more highlighted than the color of housing 41 and the color of the center console 304. In this manner, the interface controller 150 allows an occupant to easily recognize an insertion position of the display device 32 by lighting on the indicator 47. It is to be noted that when the display device 32 is retained by the display device retainer 40, the interface controller 150 turns off the indicator 47.

Also, when the vehicle M switches from automatic driving to manual driving by the switching controller 142, the interface controller 150 may notify an occupant that the display device 32 should be retained by the display device retainer 40. In this case, the interface controller 150 displays a message on the screen of the display device 32 stating that the display device 32 should be retained by the display device retainer 40. Also, the interface controller 150 may output a voice message from a loudspeaker of the HMI 30 stating that the display device 32 should be retained by the display device retainer 40, or may display a message on the display of the HMI 30 other than the display device 32 stating that the display device 32 should be retained by the display device retainer 40.

Also, when automatic driving is switched to manual driving and the display device 32 has been detached from the display device retainer 40, the interface controller 150 may light on or flicker the indicator 47 with a predetermined color. Here, for instance, when the display device 32 has been detached from the display device retainer 40, the predetermined color is a color different from the color of the indicator 47 which is lit on at the time when detached. When the indicator 47 is flickered, the predetermined color may be the same as the color of the indicator 47 which is lit on at the time when detached. Also, when automatic driving is switched to manual driving, the interface controller 150 may light on or flicker the indicator 47 with a predetermined color regardless of whether or not the display device 32 has been detached from the display device retainer 40.

Also, when the display device 32 is not retained by the display device retainer 40 during a period in which automatic driving is switched to manual driving, the interface controller 150 may display nothing on the display device 32. In other words, when the vehicle M is in manual drive, and the display device 32 is not retained by the display device retainer 40, the interface controller 150 performs control to display nothing on the display device 32. Consequently, it possible to avoid viewing of the display device 32 by an occupant near at hand during manual driving.

### Processing Flow

Hereinafter, the processing flow of the display system according to the embodiment will be described. FIG. 13 is a flowchart illustrating an example of the display system according to the embodiment. The processing flow illustrated in FIG. 13 may be repeatedly executed at predetermined timings or periods. In the example of FIG. 13, the display device retention controller 160 determines whether or not the vehicle M is in automatic drive (step S100). When automatic drive is not in operation (in other words, the vehicle M is in manual drive), the display device retention controller 160 causes the display device retainer 40 to retain the display device 32 at a position at which the display screen of the display device 32 has the first exposure amount (step S102). Also, when automatic drive is in operation, the display device retention controller 160 causes the display device retainer 40 to retain the display device 32 at a position at which the display screen of the display device 32 has the second exposure amount different from the first exposure amount (step S104).

Next, the interface controller 150 generates an image in which the content is complete, by the exposed portion of the display device 32 (step S106), and displays the generated image on the exposed portion of the display device 32 (step S108).

### Modification

Next, a modification of the display system will be described. According to the embodiment described above, the display device retainer 40 retains the display device 32 in a standing state so that the display screen of the display device 32 faces −X direction. However, the display device retainer 40 may retain the display device 32 so that the display screen faces upward (Z direction).

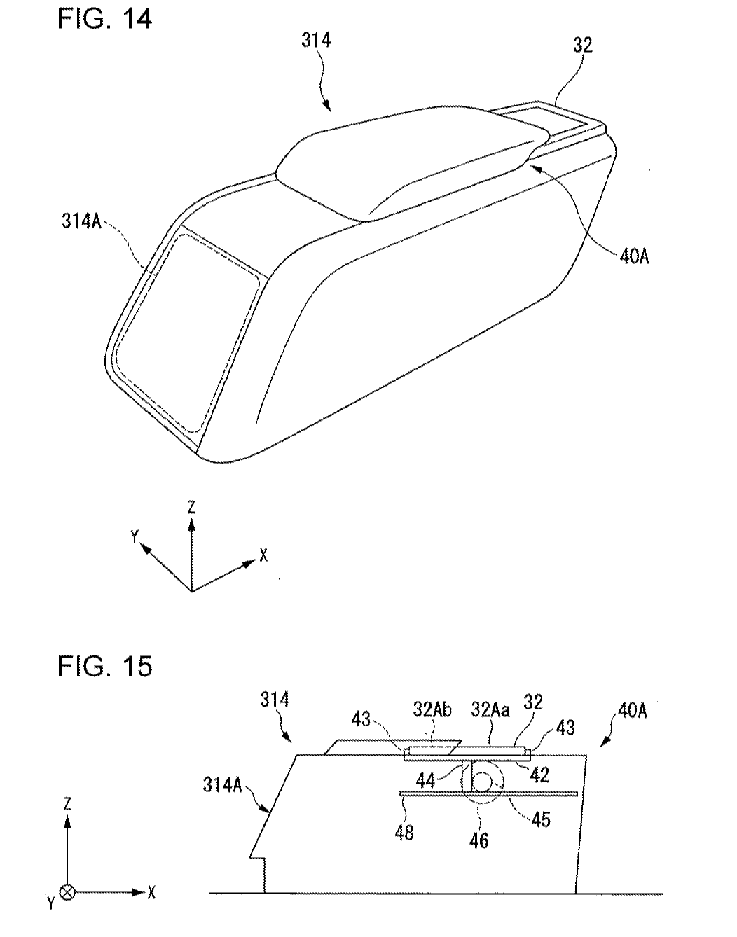

FIG. 14 is a perspective view illustrating an example of a center console 314 provided with a display device retainer 40A. As illustrated in FIG. 14, the display screen of the display device 32 is retained in a state where the surface of the display screen faces upward. With the surface of the display screen facing upward, each occupant sitting on the driver seat and the front passenger seat can visually recognize an image displayed on the display device 32. The display device retention controller 160 changes the exposed surface of the display device 32 according to a state of the vehicle M. It is to be noted that the console screen illustrated in FIG. 14 provides the display 314A at a position at which an occupant sitting on a rear seat can view the display 314A. The interface controller 150 displays on the display 314A an image with the same contents as the contents displayed on the exposed surface of the display device 32. Also, the interface controller 150 may display a DVD reproduced image or an image of a TV program.

FIG. 15 is a view for explaining the retention state of the display device 32 in the display device retainer 40A at the time of manual driving. The example of FIG. 15 described above illustrates a sectional view along a XZ plane of the center console 314 as viewed in −Y direction. In the example of FIG. 15, the center console 314 is provided with the display device retainer 40A. The display device retainer 40A includes, for instance, a seat 42, fixed portions 43, a hoisting and lowering shaft 44, a gear 45, a driver 46, and a slide rail 48 extending in ±X direction. The seat 42, the fixed portions 43, the hoisting and lowering shaft 44, the gear 45, and the driver 46 are the same as the components of the display device retainer 40 described above, thus a specific description is omitted here.

One end of the hoisting and lowering shaft 44 is slidably mounted on the slide rail 48. The display device retainer 40A drives the driver 46, thereby making it possible to rotate the gear 45 and move the hoisting and lowering shaft 44 in ±X direction. Therefore, the display device 32 placed and fixed by the fixed portions 43 on the seat 42 mounted on the hoisting and lowering shaft 44 can be moved in ±X direction.

When the vehicle M is in manual drive, the display device retention controller 160 causes the display device retainer 40A to retain the display device 32 so that the display screen of the display device 32 has the first exposure amount. Also, the interface controller 150 displays an image in which the content is complete, by the exposed surface 32Aa.

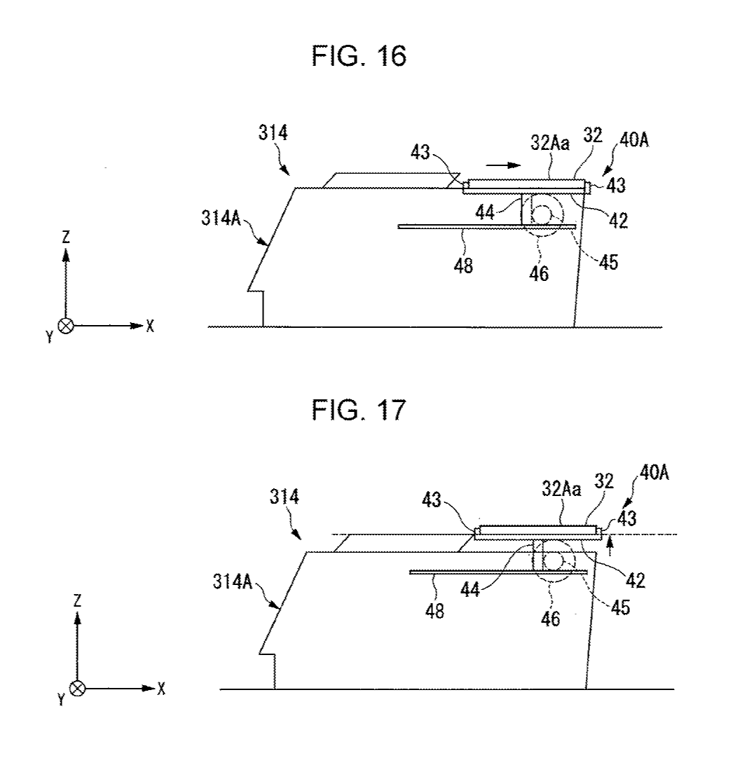

FIG. 16 is a view for explaining the retention state of the display device 32 in the display device retainer 40A at the time of automatic driving. When the vehicle M is in automatic drive, the display device retention controller 160 causes the display device retainer 40A to retain the display device 32 so that the display screen of the display device 32 has the second exposure amount which is greater than the first exposure amount. Also, the interface controller 150 displays an image in which the content is complete, by the exposed surface 32Aa.

Also, the display device retention controller 160 may raise the seat 42 up to a predetermined height so that an occupant can easily detach the display device 32 from the display device retainer 40A at the time of automatic driving. FIG. 17 is a view for explaining the manner in which the seat 42 is raised in the display device retainer 40A. The display device retention controller 160 raises the seat 42 up to a position at which the upper surface (the mounting surface of the display device 32) of the seat 42 is substantially parallel to the upper surface of the center console 314. Consequently, the display device 32 is placed at a position near eyes, and thus the display contents can be easily viewed and the display device 32 can be easily detached by an occupant. Also, the upper surface of the display device retainer 40A can be horizontal with the display device 32 detached, which does not cause a feeling of strangeness.

As described above, with the display system according to the embodiment, information according to a state of the vehicle may be provided. For instance, with the display system according to the embodiment, the exposure amount of the display device 31 is made physically variable according to one of automatic driving and manual driving, and not all menus are displayed but display is changed to minimum necessary information during driving, such as information on the in-vehicle equipment, while internally keeping various operational menus. Consequently, driver distraction can be reduced.

Also, according to the embodiment, the display device 32 is detachable at the time of automatic driving, and an operation near at hand is possible. Thus the display device 32 can be operated even at a position away from the center console 304.

According to the embodiment, the display device 32 is retainable at multiple retention positions and detachable according to usage of the display device 32 and conditions of the vehicle M, thus convenience can be improved. In addition, at the time of automatic driving, a highly flexible operation can be performed on the display device 32 and more information can be viewed via the display device 32, and thus convenience can be further improved.

In the embodiment described above, the display device retention controller 160 changes the exposure amount of the display device 32 between automatic driving and manual driving, however, in addition to this (instead of this), the display device retention controller 160 may change the exposure amount of the display device 32 according to a degree of automatic driving. For instance, a first degree of automatic driving is such that an occupant does not operate the driving operation unit 80 of the vehicle M, and the vehicle M is in automatic drive by automatically controlling at least one of acceleration/deceleration and steering of the vehicle M provided that an occupant is obligated to monitor the surroundings. In addition, a second degree of automatic driving is such that the degree of control is higher than the degree of control of the first degree of automatic driving, and any occupant is not obligated to monitor the surroundings. In this case, the display device retention controller 160 retains the display device 32 with the exposure amount of the display device 32 when the second degree of automatic driving is in operation greater than the exposure amount of the display device 32 when the first degree of automatic driving is in operation.

Also, the display device retention controller 160 may retain the display device 32 so that the exposure amount of the display device 32 is varied between when a driving assistance system not an automatic driving system, such as an adaptive cruise control system (ACC) or a lane keeping assistance system (LKAS) is operated and when a driving assistance system is not operated. In this case, the display device retention controller 160 retains the display device 32 with the exposure amount of the display device 32 when a driving assistance system is not in operation greater than the exposure amount of the display device 32 when a driving assistance system is in operation.

Also, the display device retention controller 160 may obtain the speed of the vehicle M detected by the vehicle sensor 70, and may change the exposure amount of the display device 32 according to the obtained speed of the vehicle M. In this case, the display device retention controller 160 changes the retention position of the display device 32 retained by the display device retainer 40 so that the exposure amount of the display device 32 when the speed detected by the vehicle sensor 70 is a high speed is smaller than the exposure amount of the display device 32 when the speed is a low speed. The high speed is a speed higher than or equal to a first predetermined speed (for instance, 50 to 80 [km/h]), and the low speed is a speed lower than or equal to a second predetermined speed (for instance, 30 to 40 [km/h]). Consequently, the retention state of the display device 32 can be changed according to a speed of the vehicle M.

Although the modes for carrying out the present disclosure have been described using the embodiment, the present disclosure is not limited to the embodiment, various modifications and substitutions may be made within a scope not departing from the essence of the present disclosure.

What is claimed is:

1. A display system for a vehicle comprising:
a display configured to display an image;
a retainer configured to retain the display in a predetermined location in a vehicle cabin in such a manner that the display is set in one retention position of a plurality of retention positions which allow the display to be exposed in the vehicle cabin with different exposure amounts corresponding to the respective retention positions, the one retention position of the display being changed among the plurality of retention positions according to a state of the vehicle; and
a display controller configured to cause the display to display the image of different contents depending upon the retention position at which the display is retained by the retainer.

2. The display system according to claim 1,
wherein the display controller causes the display to display the image of the content which is complete within an exposed portion of the display.

3. The display system according to claim 1,
wherein the plurality of retention positions allow an upper end of the display to be set with respective different heights.

4. The display system according to claim 1, further comprising:
an automatic drive controller configured to perform a driving mode which comprises automatic driving to control one or both of steering and acceleration/deceleration of the vehicle without an operation by an occupant of the vehicle, the driving mode defining the state of the vehicle,
wherein the retainer changes the retention position of the display according to the driving mode such that the exposure amount of the display when the driving mode is the automatic driving is greater than the exposure amount of the display when the driving mode is not the automatic driving.

5. The display system according to claim 4,
wherein when the automatic driving is performed by the automatic drive controller, the retainer allows the display to be detached.

6. The display system according to claim 4, further comprising:
an indicator configured to indicate a position of the retainer,
wherein when the vehicle is switched from the automatic driving to manual driving by the occupant, the display controller causes the indicator to light on or blink.

7. The display system according to claim 5, further comprising:
an indicator configured to indicate a position of the retainer,
wherein when the vehicle is switched from the automatic driving to manual driving by the occupant and the display has been detached from the retainer, the display controller causes the indicator to light up or blink.

8. The display system according to claim 1,
wherein the display is a touch panel by which contact to a display area by an operator is detectable, and
the display controller causes the display to display the image which allows the operator to operate a device mounted in the vehicle via the contact.

9. The display system according to claim 1,
wherein the retainer is included in a center console in the vehicle cabin.

10. The display system according to claim 1, further comprising a vehicle speed sensor configured to detect a speed of the vehicle,
wherein the retainer changes the retention position of the display depending upon the speed of the vehicle such that the exposure amount of the display when the vehicle is running at a first speed is smaller than the exposure amount of the display when the vehicle is running at a second speed which is lower than the first speed.

11. A display method performed by a computer in a vehicle, the method comprising:
retaining a display that displays an image in a predetermined location in a vehicle cabin in such a manner that the display is set in one retention position of a plurality of retention positions which allow the display to be exposed in the vehicle cabin with different exposure amounts corresponding to the respective retention positions;
changing the one retention position of the display among the plurality of retention positions according to a state of the vehicle; and
controlling the display to display the image of different contents depending upon the retention position at which the display is retained.

12. A program causing a computer to execute process comprising:
retaining a display that displays an image in a predetermined location in a vehicle cabin in such a manner that the display is set in one retention position of a plurality of retention positions which allow the display to be exposed in the vehicle cabin with different exposure amounts corresponding to the respective retention positions;
changing the one retention position of the display among the plurality of retention positions according to a state of a vehicle; and
causing the display to display the image of different contents depending upon the retention position at which the display is retained.
